(19) United States
(12) Patent Application Publication
(10) Pub. No.: US 2003/0060547 A1
(43) Pub. Date: Mar. 27, 2003

(54) Polypropylene/calcium carbonate nanocomposites

(76) Inventors: Chi-Ming Chan, Kowloon (HK); Jingshen Wu, Kowloon (HK); Jiang Xion Li, Kowloon (HK); Ying-Kit Cheung, Central (HK)

Correspondence Address: FOLEY & LARDNER, Firstar Center, 777 East Wisconsin Avenue, Milwaukee, WI, 53202-5367, US

(21) Appl. No.: 09/912,269

(22) Filed: Jul. 24, 2001

(51) Int. Cl. C08K 5/09

(52) U.S. Cl. 524/322; 524/425; 524/582; 524/586

(57) ABSTRACT

The present invention provides a composite material comprising calcium carbonate particles dispersed within a polypropylene matrix, wherein the calcium carbonate particles have a size within the range of 1 to 100 nm and a filling ratio of less than about 30% by volume, more preferably less than about 10% by volume. The particles have a mean size of around 40 to 50 nm.

### FIELD OF THE INVENTION

This invention relates to novel materials, and in particular to novel polypropylene/calcium carbonate composite materials having improved physical characteristics.

### BACKGROUND OF THE INVENTION

The use of inorganic fillers has been a common practice in the plastics industry to improve the mechanical properties of thermoplastics, such as heat distortion temperature, hardness, toughness, stiffness and mold shrinkage. The effects of filler on the mechanical and other properties of the composites depend strongly on its shape, particle size, aggregate size, surface characteristics and degree of dispersion. In addition, physical properties such as surface smoothness and barrier properties can be achieved by using conventional micron-sized particles.

It is known that the mechanical properties of the composites are in general strongly related to the aspect ratio of the filler particles. Based on this reasoning, layered silicates such as montmorillonite, which has a fairly large aspect ratio, have been extensively studied in recent years. Nanocomposites prepared with montmorillonite show improved strength, modulus, heat distortion temperature and barrier properties. In spite of many attractive improvements in physical and mechanical properties of the polymer/(intercalated or exfoliated) clay nanocomposites, a significant drawback—low fracture toughness—has greatly limited their engineering applications. In most cases, a dramatic decrease in toughness due to the addition of clay has been reported. This represents a major challenge to researchers in the field of polymer toughening.

### PRIOR ART

Calcium carbonate has been one of the most commonly used inorganic fillers for thermoplastics, such as poly(vinyl chloride) and polypropylene (PP). Historically, it has been used to merely reduce the cost of the expensive resins. The particle size of most commercially available CaCO₃ varies from 1 to 50 μm. The results of numerous studies have indicated that the improvement in the mechanical properties of micron-sized-CaCO₃-filled composites is found to be minimum. In an early work of Levitta, et al. (Polym. Eng. Sci. 1989;19:39), the fracture toughness of PP/CaCO₃ composite with and without surface treatment was evaluated. Both untreated and surface-treated CaCO₃ with a particle size of about 70 μm was used. The authors found that the fracture toughness, in terms of the mode-I stress intensity factor (K_{IC}), of the PP with surface-treated CaCO₃ increased slightly. Compared with pure PP, a 20% increase in K_{IC} was noticed at 10% filler content. Addition of more than 10% filler, however, decreased the K_{IC} of the nanocomposites drastically. In a recent work reported by Rong, et al (Polymer 2001; 42:167 and Polymer 2001; 42:3301), very fine SiO₂ nanoparticles (˜7 nm) were compounded with PP. The tensile strength of the nanocomposite with 0.65 vol % SiO₂ filler was 18% higher than that of pure PP. A further increase in the filler content did not have much influence on the tensile strength of the nanocomposites. The authors also reported a substantial increase in toughness owing to the incorporation of nano-SiO₂. However, it is worth noticing that the toughness reported by the authors is actually the energy to break measured in a uniaxial tensile test. It is well known that high tensile toughness does not necessarily mean high fracture toughness. The latter is measured with sharply notched specimens under a strictly defined test condition. Generally speaking, notched fracture toughness of a given polymer will be lower or much lower compared with tensile toughness simply because many energy-dissipating events occurring during a plane-stress testing (such as in uniaxial tension) cannot take place easily when the specimen is subjected under plane-strain condition (e.g. in notched fracture toughness test). Unfortunately, many catastrophic material failures in engineering applications are caused by the low plane-strain fracture toughness of the materials. Hence, the notched fracture toughness is always regarded as a critical parameter in material selection.

In addition, when surface smoothness and high gloss is required, micron-sized CaCO₃ cannot be used.

Polypropylene is one of the commodity plastics that have the highest growth rate. The incorporation of CaCO₃ in PP is a common practice to improve the heat distortion temperature, dimensional stability, stiffness and hardness of the polymer. However, the addition of micron-sized-CaCO₃ particles to PP has not shown significant improvement in the mechanical properties of the composites. One of the key factors is believed to be the poor filler-polymer interaction. Many efforts have been devoted to surface-modified CaCO₃ particles to increase the polymer-filler interactions. The effects of surface modification on mechanical properties have been positive.

### SUMMARY OF THE INVENTION

According to the present invention there is provided a composite material comprising calcium carbonate particles dispersed within a polypropylene matrix, wherein said calcium carbonate particles have a size within the range of 1 to 100 nm and a filling ratio of less than about 30% by volume.

Preferably the filling ratio is less than about 10% by volume.

Preferably the particles have a mean size of around 40 to 50 nm.

In this context it should be understood that the particles will have an irregular shape and so the word “size” should be interpreted in that context. The calcium carbonate particles will not be perfectly spherical and so the term diameter is not strictly accurate, but the term “size” may be regarded as the maximum dimension of a particle.

In a preferred embodiment the particles are provided with an organic coating to enhance the compatibility of the particles and said polypropylene matrix. The organic coating may be stearic acid, a titanate coupling agent or a silane coupling agent.

Viewed from another aspect the present invention provides a method of forming a composite material comprising mixing calcium carbonate particles within a polypropylene matrix so as to form a homogeneous dispersion of said particles within said matrix, said particles having a size within the range of 1 to 100 nm and a filling ratio of less than about 30% by volume.

Preferably the filling ratio is less than about 10%.

Preferably the particles have a size of about 40 to 50 nm.

The mixing may be carried out in a batch mixer for 15 to 30 minutes, and preferably at a temperature of about 180° C. The mixing may also be carried out in a twin-screw extruder.

Preferably the calcium carbonate particles are coated with a layer which consists mostly of stearic acid and other organic materials prior to the mixing. The organic material may be a titanate or silane coupling agent.

### BRIEF DESCRIPTION OF THE DRAWINGS

Some embodiments of the invention will now be described by way of example and with reference to the accompanying drawings, in which:

FIG. 1 is a plot of the TGA curve of calcium carbonate nanoparticles used in embodiments of the invention,

FIG. 2 shows TEM micrographs of calcium carbonate nanoparticles used in embodiments of the invention,

FIG. 3 shows XPS spectra of the C1s, O1s and Ca2p core levels of calcium carbonate nanoparticles used in embodiments of the invention,

FIG. 4 shows TEM micrographs of a nanocomposite material according to an embodiment of the invention,

FIG. 5 shows TEM micrographs of a nanocomposite material according to another embodiment of the invention,

FIG. 6 shows TEM micrographs of a nanocomposite material,

FIG. 7 plots the Izod impact strength as a function of mixing time,

FIG. 8 plots melting curves of pure polypropylene and composite materials according to embodiments of the invention,

FIG. 9 plots cooling curves of pure polypropylene and composite materials according to embodiments of the invention,

FIG. 10 shows SEM micrographs of (a) pure polypropylene and (b) a composite material according to an embodiment of the invention,

FIG. 11 shows stress-strain curves of materials according to the invention and pure polypropylene,

FIG. 12 shows the J-R curve of pure polypropylene,

FIG. 13 plots the J-R curve of a material according to a first embodiment of the invention,

FIG. 14 plots the J-R curve of a material according to a second embodiment of the invention,

FIG. 15 is a schematic of J-R curve construction and crack development during the test, and

FIG. 16 shows SEM micrographs of the impact fracture structure of materials according to the invention.

### DETAILED DESCRIPTION OF PREFERRED EMBODIMENTS

In the following examples of the invention, polypropylene homopolymer (PD 403) with density 1.04 kg/L was provided by Montell USA. The calcium carbonate nanoparticles (CCR) were obtained from Guang Ping Nano Technology Group Ltd. and the anti-oxidant was Irganox 1010.

The concentration of Ca, Mg, Fe, Al and Si in the CaCO₃ nanoparticles was determined by inductively coupled plasma spectroscopy (ICP). The amount of carbon and hydrogen in the sample was determined by a carbon, hydrogen and nitrogen analyzer. The water content of the nanoparticles was measured by thermogravimetric analysis. To determine the PH of the CaCO₃ nanoparticles, 10 gm of the sample was mixed with 10 g of ethanol. Then 80 g of water was added to the mixture. The solution was filtered and the PH of the water was measured. The surface area of the CaCO₃ nanoparticles was measured by nitrogen adsorption method (BET). The particle sizes of the nanoparticles were determined by transmission electron microscopy (TEM). To prepare the nanoparticle sample for TEM examination, the CaCO₃ nanoparticles were dispersed in ethanol in an ultrasonic bath for 10 min. The average size of the primary particles was determined by measuring the sizes of the 10 randomly chosen particles. The surface chemical composition of the CaCO₃ nanoparticles was determined by using X-ray photoelectron spectroscopy (XPS).

Before mixing, polypropylene and CaCO₃ nanoparticles were dried in an oven at 120° C. for one hour and then cooled down to room temperature. The materials were stored in a desiccator prior to processing. Blending was carried out in a Haake mixer. The mixing temperature was 180° C. and the rotor speed was set at 60 rpm. The polypropylene and anti-oxidant were mixed for 1 minute before the CaCO₃ was added slowly over a period of 10 min. When all the materials were added into the mixing chamber, the materials were further mixed for a fixed period of time. After mixing, the compound was cut into small pieces.

A vertical injection molding machine (Morgan Press) was used for preparing the samples for mechanical tests. The operating conditions are shown in Table 1.

TABLE 1

| | |
|---|---|
| Barrel Temperature | 200° C. |
| Nozzle Temperature | 210° C. |
| Upper Mould Temperature | 40° C. |
| Lower Mould Temperature | 50° C. |
| Mould Clamp Force | 10 tons |
| Injection Pressure | 4.5 × 10⁵ psi |

Tensile (ASTM-D638, type IV) and impact bars (ASTM-D256) of pure polypropylene and the nanocomposites were prepared. Prior to the mechanical testing, both the tensile and impact bars were conditioned at the temperature of 23±2° C. and the relative humidity 50±5 % for 40 hours.

Crystallinity of the nanocomposites was examined using differential scanning calorimetry (DSC) (TA2910). The temperature of the instrument was calibrated with Indium and the baseline was checked using sapphire. All tests were performed in nitrogen atmosphere with a sample weight about 8-10 mg. For each test, the sample was first heated to 200° C. at 10° C./min and then annealed for 5 minutes to destroy any residual nuclei and to ensure an identical thermal history. The specimen was subsequently cooled down to room temperature at a cooling rate of 5° C./min for data collection.

The tensile experiment was performed with a tensile tester (Instron 5567) at a crosshead speed of 5 mm/minute. Before the tensile testing, the width and the thickness of the specimens were measured with a micrometer. The tensile modulus of the samples was determined at 0.5% strain and the tensile strength at yield was determined according to ASTM-D638. Five specimens of each sample were tested and the mean values and standard deviations were calculated.

The impact test was performed following the ASTM-D256 method. Notching was done on a CSI Automatic notcher (CS-93M). The table feed rate and the cutter speed were 100 mm/min and 92 m/min, respectively. Prior to the testing, the notched specimens were conditioned at the temperature of 23±2° C. and the relative humidity 50%±5% for 40 hours. Before the impact testing, the depth and the width of the specimens were measured with a micrometer. The specimens were tested using an impact tester (Tinius Olsen 92T). Ten specimens of each sample were tested and the mean values and standard deviations were calculated.

The J-integral test was conducted on a universal testing machine (Sintech 10/D) at room temperature following ASTM Standard E813-87. Single edge notched three-point bending (SEN-3PB) specimen geometry was adopted. The dimensions of the SEN-3PB specimen were 3.5 mm in thickness (B), 12.5 mm in width (w) and 65 mm in length (L). A pre-crack, a, of approximately 6.2 mm (i.e. a/W=0.5) was introduced at the center of one edge of the rectangular bars. The pre-crack consisted of a saw slot and a sharp crack tip, which was created by pushing a fresh razorblade at the bottom of the saw slot. The crosshead speed was 10 mm/min and multiple specimen technique was employed in the construction of the J-R curves.

Following the experimental procedure of the multiple specimen technique, the specimen was unloaded when the load-displacement curve reached a certain position where a required crack extension was attained. The deformed specimen was then immersed in a liquid nitrogen bath for 20 minutes. The frozen specimen was fast fractured by a hammer and wedge immediately after the liquid nitrogen treatment. The length of the stress-whitened zone between the end of the pre-crack and the commencement of the fast fracture was regarded as the true crack extension, Δa, which was measured by a traveling microscope.

The results of the nanoparticle characterization are summarized in Table 2.

TABLE 2

| Analysis | | Results |
|---|---|---|
| Composition (wt %) | C | 12.9 |
| | O | 44.2 |
| | H | 0.5 |
| | Ca | 41.6 |
| | Al | 0.2 |
| | Mg | 0.6 |
| | Fe | 0.0 |

| | |
|---|---|
| Water content (wt %) | <1.0 |
| PH value | 8.8 |
| Surface area (m²/g) | 28.0 |
| Particle size range (μm) | 0.09-0.03 |
| Average primary particle size (μm) | 0.044 |
| Weight loss at 900 C. (wt %) | 46.1 |

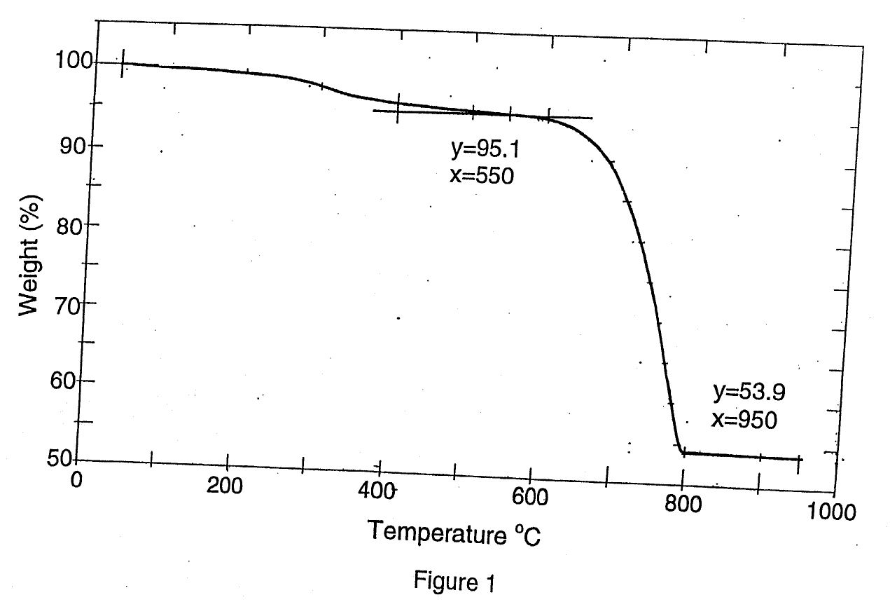

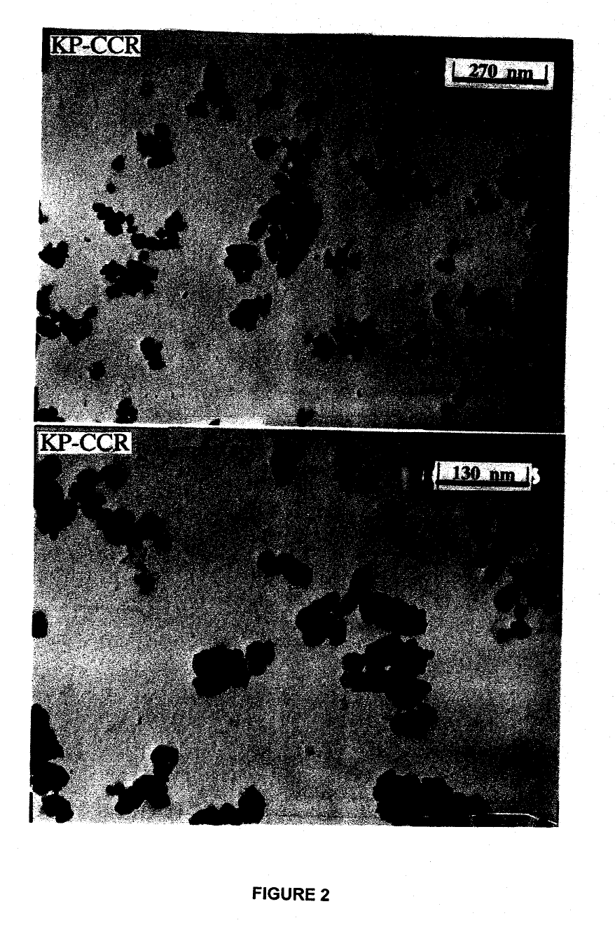

Based on the element analysis results, it can be concluded that the sample contains more than 98 wt % CaCO₃ with a small amount of impurities including MgO, Fe₂O₃ and Al₂O₃. To use these nanoparticles as filler for thermoplastics, it is important to determine their thermal stability. FIG. 1 shows the weight loss of the sample as a function of temperature. The weight loss is minimum until the temperature is above 400° C. At 550° C., the weight loss is about 5 wt %. These results indicate that these CaCO₃ nanoparticles can be used as filler for many thermoplastics because most processing temperatures are below 400° C. The TEM micrograph of the CaCO₃ nanoparticles, as shown in FIG. 2, reveals that the nanoparticles have a high structure and rough surface. Many aggregates can be seen. These results agree with the measured high surface area of 28 m²/g for these nanoparticles. Because of the aggregate nature of these nanoparticles, it is difficult to determine the primary particle size precisely. The primary particle size was determined by measuring the sizes of 10 randomly chosen particles. An average particle size of about 44 nm was obtained.

The mechanical properties of the nanocomposite materials can be enhanced significantly when the filler is surface-modified with an organic material, such as stearic acid, a titanate coupling agent or a silane coupling agent. This will improve the compatibility between the filler and polymer. The calcium carbonate nanoparticles used in this invention may be surface-modified by coating with an organic layer, which functions to strengthen the interaction between the inorganic filler and the polymer. In general, such a surface organic coating is very thin and cannot be detected easily by conventional techniques. XPS, which is also known as electron spectroscopy for chemical analysis (ESCA), is probably the most widely used technique in the surface characterization of polymers and other materials. The sampling depth of XPS is approximately 3 to 5 nm.

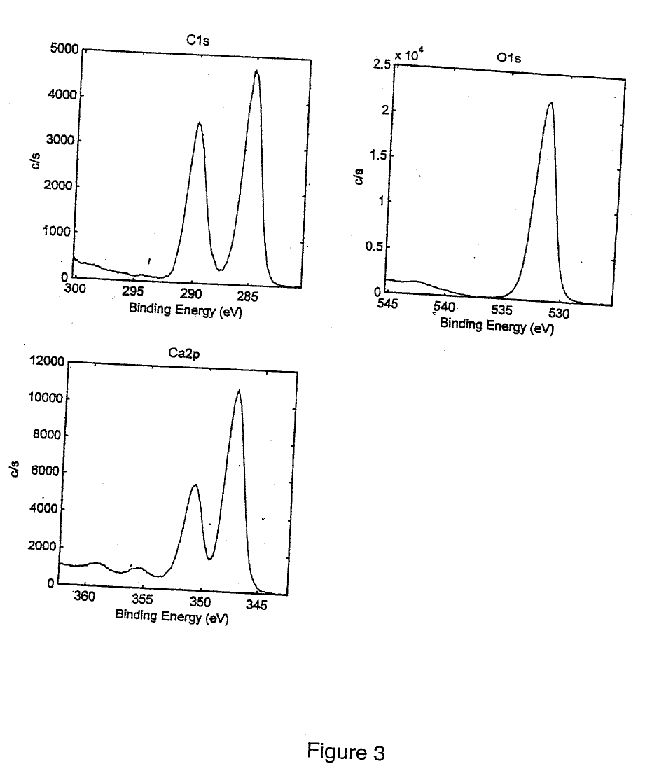

FIG. 3 shows the XPS spectra of the three major elements on the surface, including carbon, oxygen and calcium. The carbon C1s spectrum has one low binding energy peak at 285 eV, representing the carbon of a hydrocarbon and a high binding energy peak at about 290 eV, representing the carbon associated with CO₃. The concentrations of these two different types of carbon can be calculated using the areas under these two peaks. A higher organic carbon concentration on the surface indicates a higher surface coverage of the organic coating or thicker coating. Table 3 shows the XPS results.

TABLE 3

Surface chemical composition, atomic %

C

| Sample | Inorganic | organic | O | Ca |
|---|---|---|---|---|
| CCR | 16.4 | 22.8 | 46.7 | 14.1 |

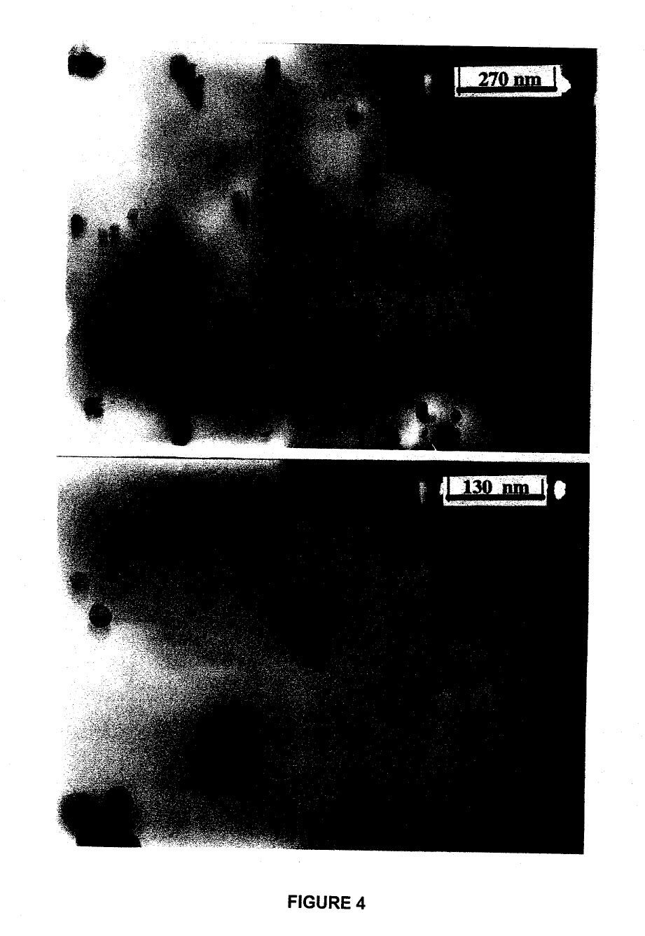

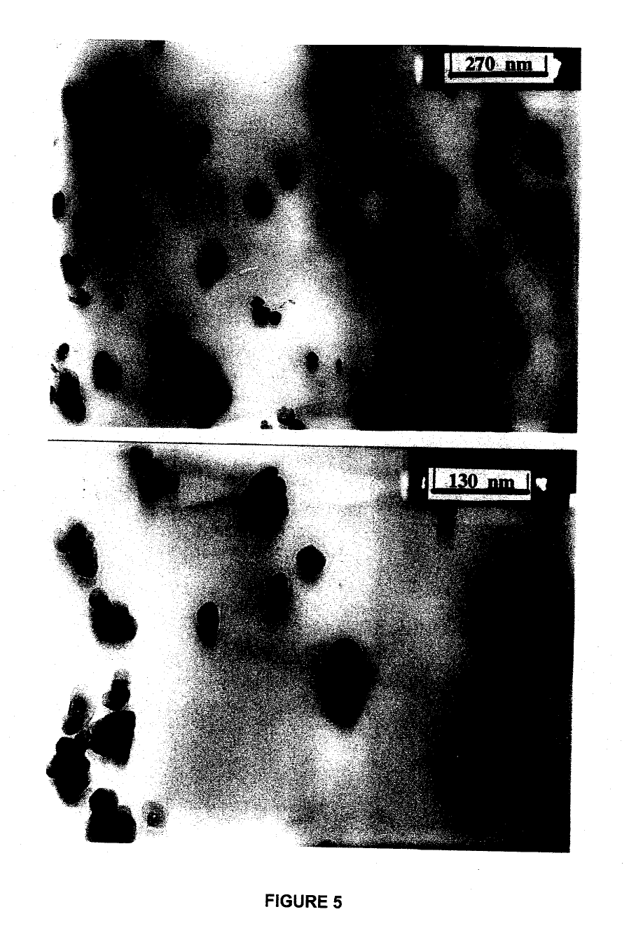

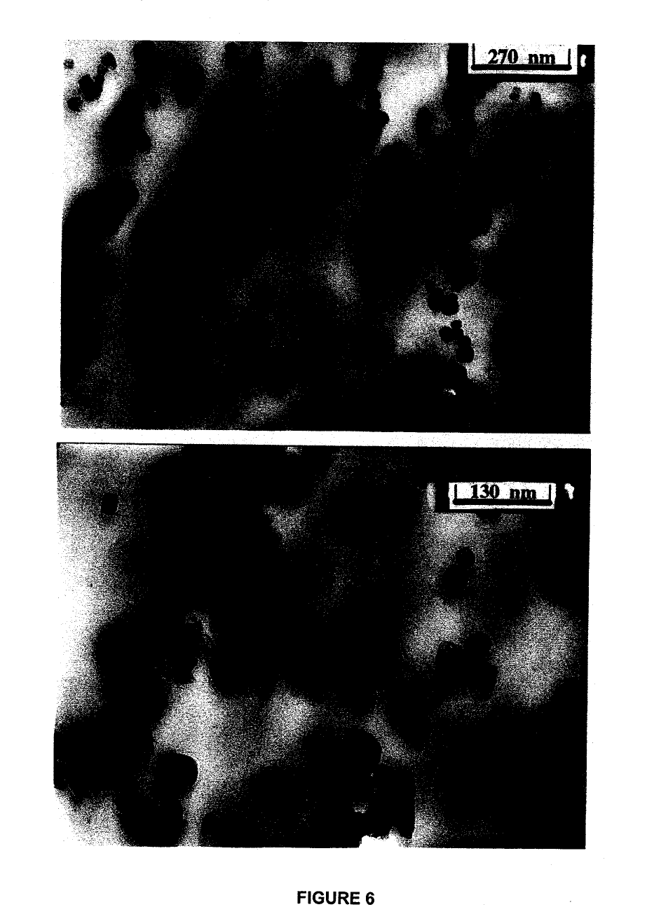

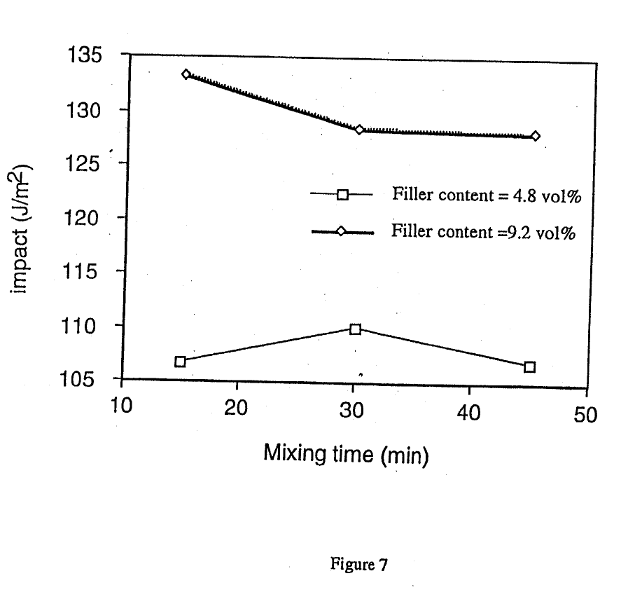

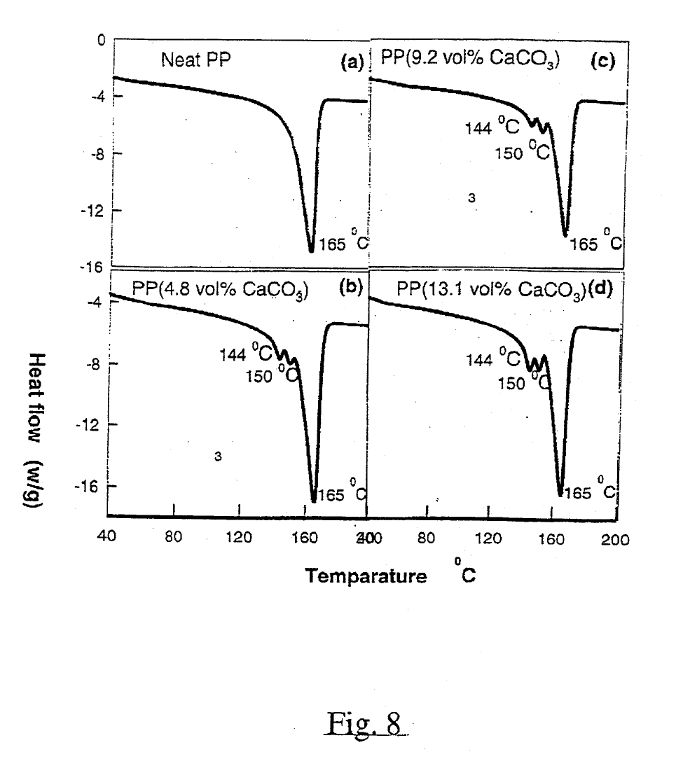

It is known that the dispersion of a filler in the polymer matrix can have a significant effect on the mechanical properties of the composites. The dispersion of an inorganic filler in a thermoplastic is not an easy process. The problem is even more severe when using nanoparticles as a filler because the nanoparticles have a strong tendency to agglomerate. Consequently, homogeneous dispersion of the nanoparticles in the thermoplastic matrix is a difficult process. A good dispersion can be achieved by surface modification of the filler particles and appropriate processing conditions. FIGS. 4-6 shows the TEM micrographs of the nanocomposites containing 4.8, 9.2 and 13.3 vol % CaCO₃. These nanocomposites were prepared with a mixing time of 30 min. For the nanocomposite with 4.8 and 9.2 vol % CaCO₃, a good dispersion is achieved. Most CaCO₃ aggregates are broken down to primary particles. This should maximize the interfacial interaction between the nanoparticles and the polymer. However, more aggregates are found for the nanocomposite with a high concentration of CaCO₃ (13.2 vol %). This is reasonable considering that at high CaCO₃ concentrations, the interparticle distance is small hence flocculation of these nanoparticles can occur after the mixing is stopped. To determine the optimal mixing time, there mixing times—15, 30 and 45 min—were used. The mechanical properties, which can be significantly affected by the dispersion of the nanoparticles in the composites, were measured. FIG. 7 shows the impact strength of the composites prepared with different mixing time. The results suggest that the impact strength is not significantly affected by mixing time. The other mechanical properties of the nanocomposites are also found not to be affected by the mixing time, as shown in Table 4 (provided at the end of this specification). These results indicate that a mixing time of 15 or 30 min is adequate.

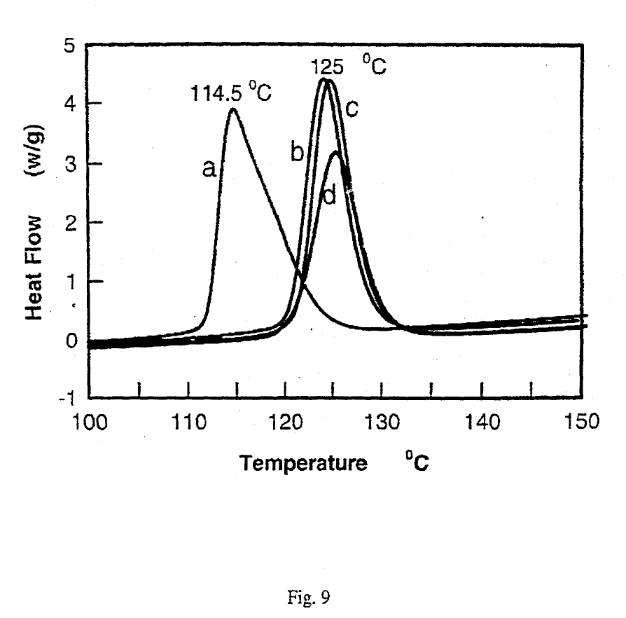

The mechanical properties of the nanocomposites can be significantly changed if the crystallization characteristics of PP have been altered. FIGS. 8-9 show the DSC curves for the pure PP and the nanocomposites with 4.8, 9.2 and 13.2 vol % CaCO₃. The presence of a small amount of beta phase, as shown in FIG. 9 can also contribute to the significant improvement in the fracture toughness. Table 5 give a summary of the crystallization and melting data of the PP and nanocomposites.

TABLE 5
The crystallization and melting data pure PP and nanocomposite
materials

| | | | Tₘ-T_{c} | |
|---|---|---|---|---|
| Sample | Tₘ (° C.) | T_{c} (° C.) | (° C.) | X_{c} (wt %) |
| PP | 165 | 114.7 | 50.3 | 51.7 |
| PP + 4.8 vol % CaCO₃ | 165 | 124.9 | 40.1 | 51.5 |
| PP + 9.2 vol % CaCO₃ | 165 | 124.2 | 40.8 | 51.0 |
| PP + 13.1 vol % CaCO₃ | 165 | 125.4 | 39.6 | 50.8 |

Tₘ = peak melting temperature.
T_{c} = peak crystallization temperature determined during cooling.
X_{c} = wt % crystallinity of PP (the standard heat of crystallization is taken to be 170 J/g)

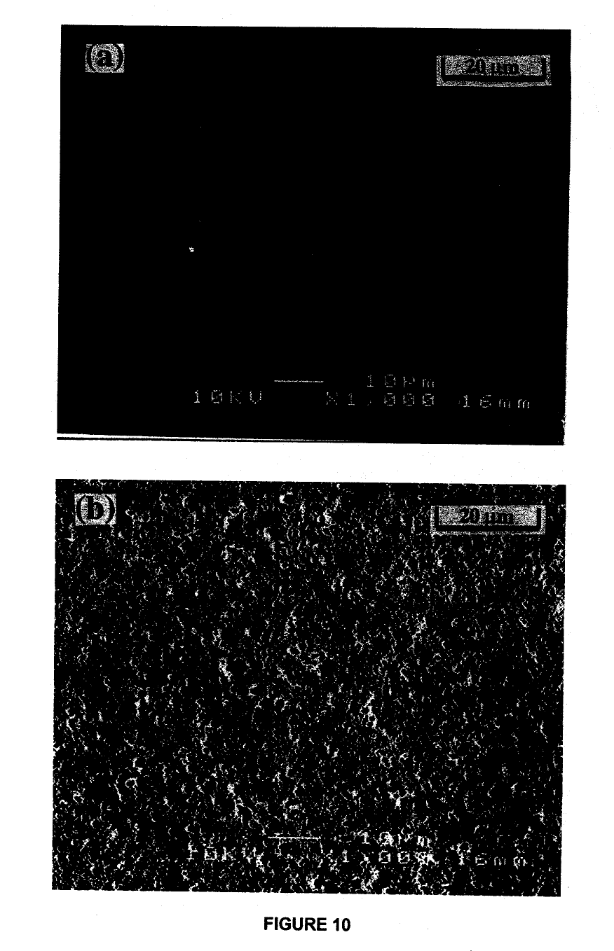

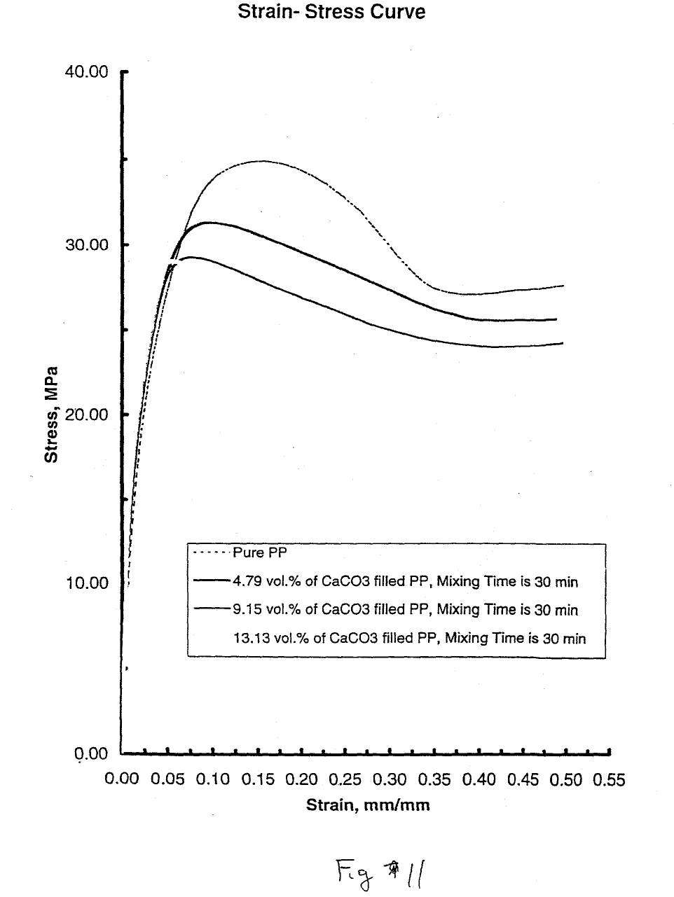

FIG. 10 shows SEM micrographs of (a) pure polypropylene and (b) a composite material in accordance with an embodiment of the invention with 9.2 vol % CaCO₃. In FIG. 10(a) the size of the spherulites is larger than 40 microns, whereas FIG. 10 (b) shows a virtual absence of spherulitic structure. In addition, the crystallizing temperature of PP is increased by approximately 12° C. when CaCO₃ is added to the PP. The results show that an increase of 12° C. in the crystallization temperature is achieved because the CaCO₃ nanoparticles are a very effective nucleating agent.

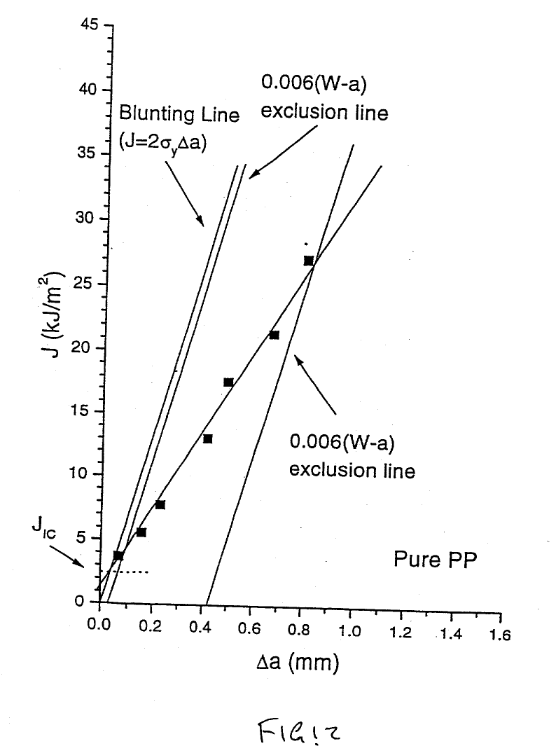

The tensile stress-strain curves of the pure PP and the nanocomposites are shown in FIG. 11. Two common equations that are frequently used to estimate the modulus of particle-filled composites are:

E_{c}=Eₚφₚ+E_{f}φ_{f} (1)

$${E}_{c} = \frac{{E}_{p} {E}_{f}}{{E}_{p} {φ}_{f} + {E}_{f} {φ}_{p}} \qquad ( 2 )$$

where E_{c} is the modulus of the composite, Eₚ and E_{f} are the moduli of the polymer matrix and filler, respectively, φₚ and φ_{f} are the volume fraction of the polymer and filler, respectively. Equation 1 is appropriate when strong adhesion exist between the filler and polymer and the filler has a large aspect ratio and Equation 2 is applicable to rigid spherical particles.

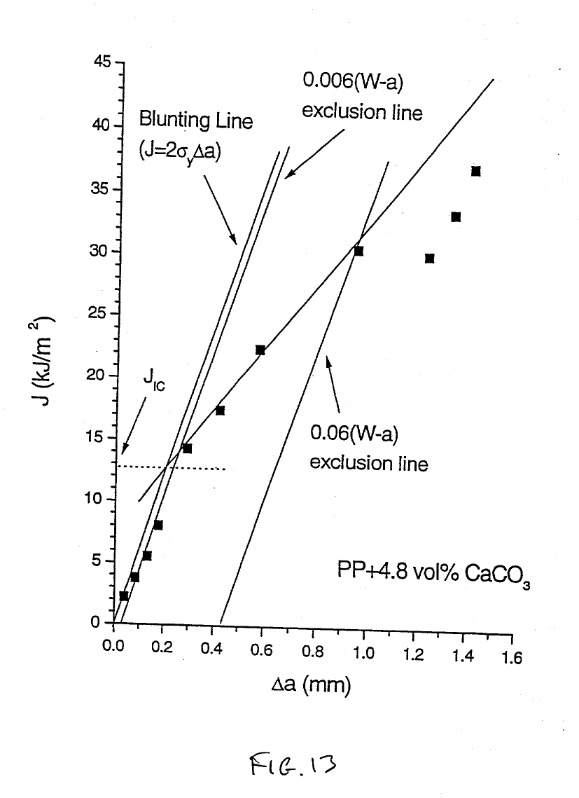

Comparing the experimental and calculated modulus, as shown in FIG. 12, it can be seen that the moduli of the composites lie between the values calculated by Equations 1 and 2. From the DSC data, it is known that the size of spherulites is reduced significantly because of the nucleating effect of the CaCO₃ nanoparticles.

In addition the dispersion of the nanoparticles will have a significant effect on the mechanical properties of the nanocomposites. The dispersion is found to be better for nanocomposites containing 4.8 and 9.2 vol % CaCO₃ nanoparticles. At filler content of 13.2 vol %, many aggregates of nanoparticles are found. This may also account for the superior mechanical properties of the nanocomposites containing the lower vol % of filler. In summary, there is a significant increase in the modulus and minor changes in the yield stress, yield strain, ultimate tensile strength and ultimate strain due to the balance between the reinforcing effect and nucleating effect of the CaCO₃ nanoparticles. In addition, the J-integral and impact strength of the nanocomposites have shown dramatic improvement as will be discussed below.

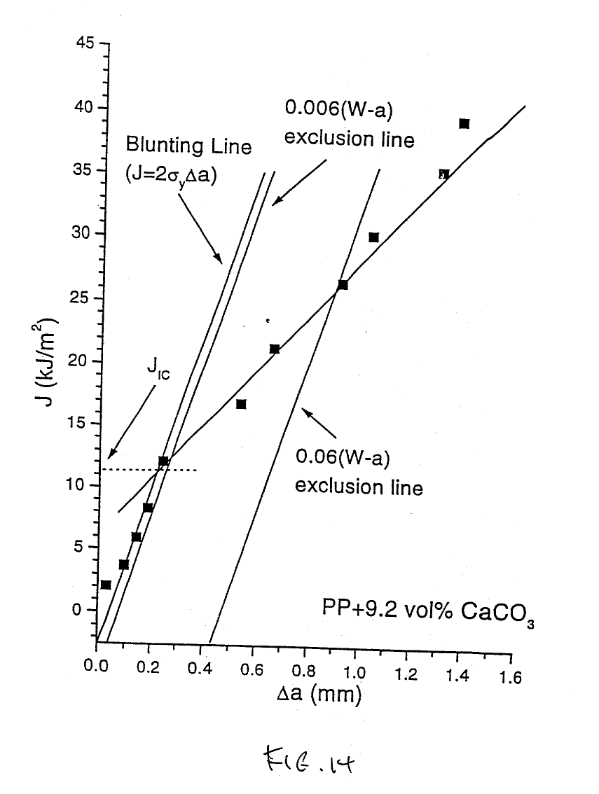

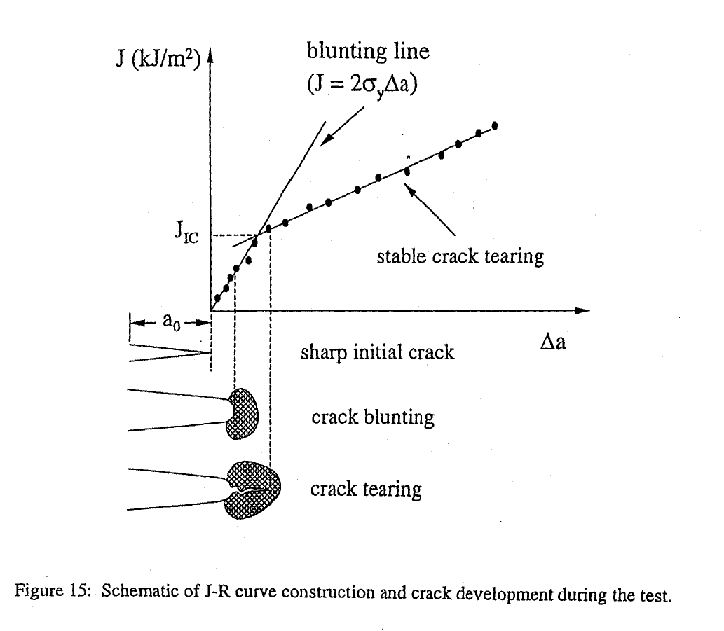

The fracture behaviour of the PP/CaCO₃ nanocomposites was determined using the rigorous J-integral analysis. The results of J-integral tests are displayed in FIGS. 13-15. The mode-I critical J-integral (J_{IC}) values for the three nanocomposites can be read from the Figures without any ambiguity; they are 2.5 kJ/m² for the pure PP as well as 12.6 and 11.3 kJ/m² for the composites with 4.8 vol % and 9.2 vol % CaCO₃ nanoparticles, respectively. In other words, the addition of a small amount of CaCO₃ nanoparticles (4.8 vol %) has resulted in a significant 500% increase in the notched fracture toughness.

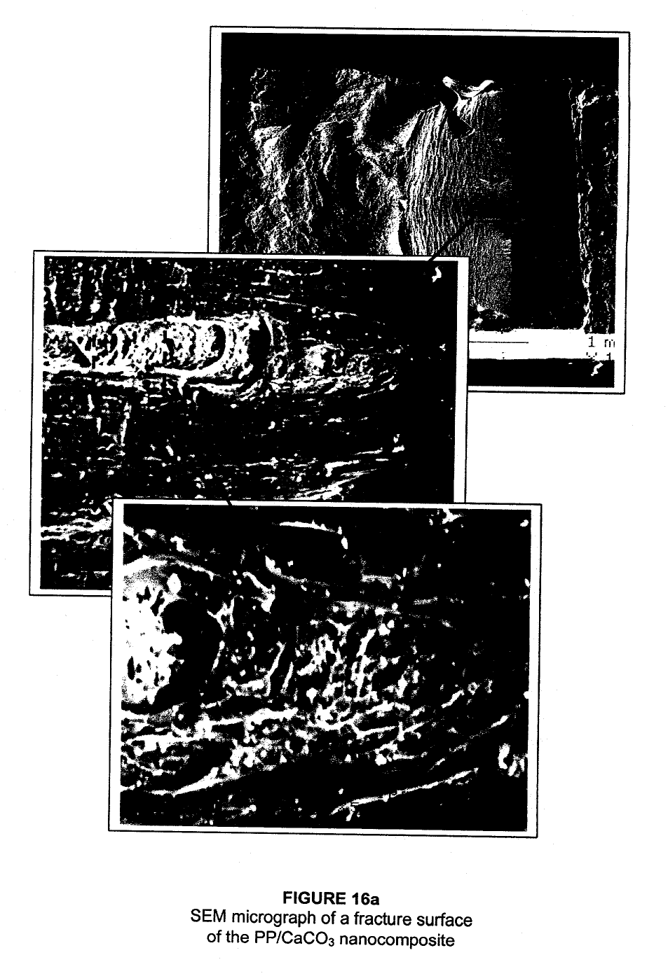

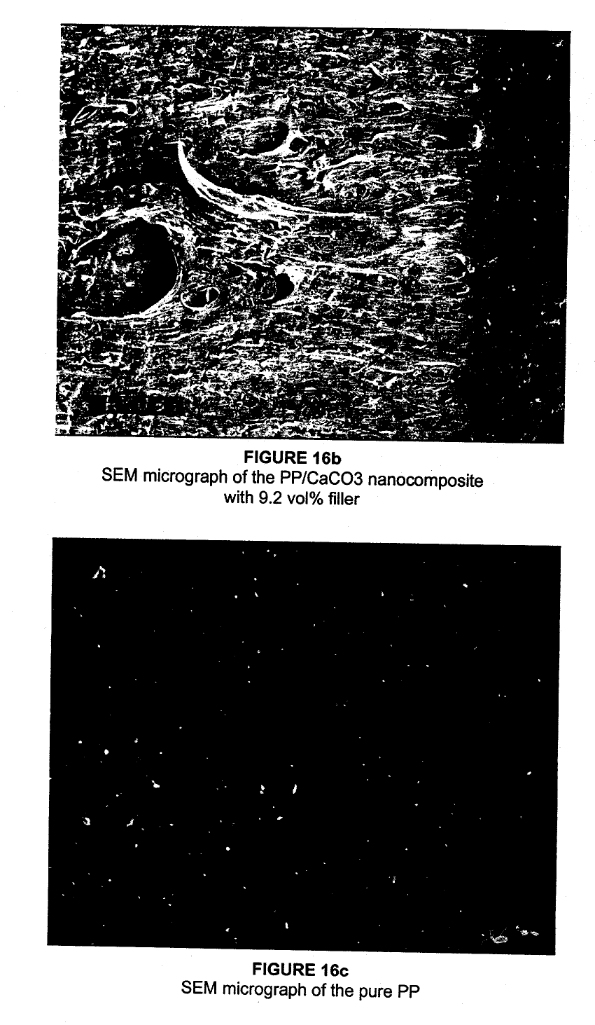

The experimental procedure for the determination of the critical J-integral is based the original suggestion given by Begley and Landes (Begley J A and Landes J D, The J-integral as Fracture Criterion, in Fracture Toughness, Corten H T and Gallagher J P (ed.) ASTM STP, 1972, 1.) The physical meaning of this procedure is schematically illustrated in FIG. 16. Obviously, the J_{IC} gives the critical J-integral value above the value of the one that a new crack at the blunted crack tip will initiate. Thus, it represents the crack initiation toughness of the tested piece. This toughness is closely related to the energy dissipating events occurring before the crack onset in the region immediately ahead of the crack tip (the shadow region in FIG. 16). For the particulate-filled semicrystalline polymers, crazing, shear banding, filler-induced cavitation and the cavitation-trigged-matrix shearing have been identified as the major energy dissipating mechanisms.

As fracture toughness of polymer materials depends very much on the mobility (relaxation time) of the polymer chains under the testing condition, thus, both temperature and deformation rate have great influences on the fracture behaviour. It is not uncommon that a material showing a high quasi-static fracture toughness has a poor impact strength. A good example is polybutylene terephthalate (PBT), which is highly strain rate sensitive. In many cases, the strain-rate embrittlement is due to that the toughening mechanisms that readily occur in the quasi-static loading condition are suppressed by the high strain rate in the impact test.

However, this is not the case in the materials of the present invention. As demonstrated in FIG. 7, the impact strength of the PP nanocomposites (mixing time=30 min) increases with the filler content reaching a peak value of about 128 J/m at the filler content of 9.2 vol %. Compared with the pure PP (55.2 J/m), the improvement in impact strength owing to the addition of the nanoparticles is about 2.5 times. This represents a substantial improvement. Although the exact micromechanical deformation mechanisms in impact are still under investigation it is reasonable to believe that the cavitation induced massive shear deformation, is plausibly the main toughening mechanism.

It will thus be seen that at least in preferred forms of the present invention there are provided PP composites with CaCO₃ nanoparticles (˜44 nm). The notched fracture toughness of the nanocomposites under either quasi-static or impact loading conditions is substantially higher than that of the pure PP. TEM study shows that the nanoparticles are distributed in the PP matrix uniformly and little particle agglomeration was found at 4.8 and 9.2 vol %. A thermal analysis on the PP and the composites revealed that the addition of the nanoparticles into the PP matrix resulted in a noticeable change of the structure of the spherulites. The CaCO₃ nanoparticles were found to be an effective nucleating agent. Fractographies of the broken specimens from the J-integral tests suggested that the nanoparticles introduce a massive number of stress concentration sites in the matrix and promote cavitation at the particle-matrix boundary when loaded. The cavities, in turn, release the plastic constraint and trigger large-scale plastic deformation of the matrix, which consumes tremendous fracture energy.

1. A composite material comprising calcium carbonate particles dispersed within a polypropylene matrix, wherein said calcium carbonate particles have a size within the range of 1 to 100 nm and a filling ratio of less than about 30% by volume.

2. A composite material as claimed in claim 1 wherein the filling ratio is less than about 10% by volume.

3. A composite material as claimed in claim 1 wherein said particles have a mean size of around 40 to 50 nm.

4. A composite material as claimed in claim 1 wherein said particles are provided with an organic coating to enhance the compatibility of the particles and said polypropylene matrix.

5. A composite material as claimed in claim 4 wherein said organic material is stearic acid or a titanate coupling agent or a silane coupling agent.

6. A method of forming a composite material comprising mixing calcium carbonate particles within a polypropylene matrix so as to form a homogeneous dispersion of said particles within said matrix, said particles having a size within the range of 1 to 100 nm and a filling ratio of less than about 30% by volume.

7. A method as claimed in claim 6 wherein the filling ratio is less than about 10%.

8. A method as claimed in claim 6 wherein said particles have a size of about 40 to 50 nm.

9. A method as claimed in claim 6 wherein said calcium carbonate particles are coated with a layer of an organic material prior to said mixing.

10. A method as claimed in claim 9 wherein said organic material is stearic acid or a titanate coupling agent or a silane coupling agent.
